(19) United States
(12) Patent Application Publication
(10) Pub. No.: US 2011/0219628 A1
(43) Pub. Date: Sep. 15, 2011

(54) POWER TOOL WITH DEBRIS COLLECTION ASSEMBLY

(76) Inventors: Ryan Harrison, Anderson, SC (US); Robert E. McCracken, Anderson, SC (US)

(21) Appl. No.: 12/722,174

(22) Filed: Mar. 11, 2010

(51) Int. Cl. B27B 9/00; B23D 45/16; B27G 19/04; B27G 19/08; B26D 7/18

(52) U.S. Cl. 30/124; 30/374; 30/286; 83/102.1; 83/167

(57) ABSTRACT

A power tool includes a motor, a cutting element operably coupled to the motor and configured to remove material from a workpiece, a base configured to support the cutting element relative to the workpiece, and a receptacle positioned beneath the base and configured to be positioned beneath the workpiece to collect debris generated by the cutting element beneath the workpiece as material is removed from the workpiece.

### FIELD OF THE INVENTION

The present invention relates to power tools, and more particularly to power tools incorporating debris collection assemblies.

### BACKGROUND OF THE INVENTION

Circular saws often utilize vacuum attachments to collect debris (e.g., chips, dust, particulate matter, shavings, etc.) that is generated when cutting a workpiece. While useful for collecting most of the debris generated during a cutting operation, some debris may nevertheless be released to the surroundings in which the saw is used.

### SUMMARY OF THE INVENTION

The invention provides, in one aspect, a power tool including a motor, a cutting element operably coupled to the motor and configured to remove material from a workpiece, a base configured to support the cutting element relative to the workpiece, and a receptacle positioned beneath the base and configured to be positioned beneath the workpiece to collect debris generated by the cutting element beneath the workpiece as material is removed from the workpiece.

The invention provides, in another aspect, a debris collection assembly for use with a circular saw. The circular saw includes a circular saw blade, a base configured to support the saw blade relative to a workpiece, and a lower guard positionable to at least partially cover a lower portion of the saw blade. The debris collection assembly includes a support configured to be coupled to the base, a receptacle coupled to the support and configured to be positioned beneath the base and the workpiece to collect debris generated by the saw blade beneath the workpiece as material is removed from the workpiece, and a locking assembly coupled to at least one of the support and the receptacle. The locking assembly is adjustable between a first configuration, in which the position of the receptacle relative to the support is fixed, and a second configuration, in which the position of the receptacle relative to the support is adjustable.

Other features and aspects of the invention will become apparent by consideration of the following detailed description and accompanying drawings.

### BRIEF DESCRIPTION OF THE DRAWINGS

FIG. 1 is a front perspective view of a power tool of the invention incorporating a debris collection assembly.

FIG. 2 is an exploded, perspective view of the debris collection assembly of FIG. 1.

FIG. 3 is a partial cross-sectional view of the power tool of FIG. 1 along line 3-3 in FIG. 4.

FIG. 4 is a side view of the power tool of FIG. 1, illustrating the debris collection assembly in a first configuration to accommodate a workpiece having a first thickness.

FIG. 5 is a side view of the power tool of FIG. 1, illustrating the debris collection assembly in a second configuration to accommodate a workpiece having a second thickness greater than the first thickness.

FIG. 6 is a side view of the power tool of FIG. 1, illustrating the power tool cutting a workpiece with accumulated debris in the debris collection assembly.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

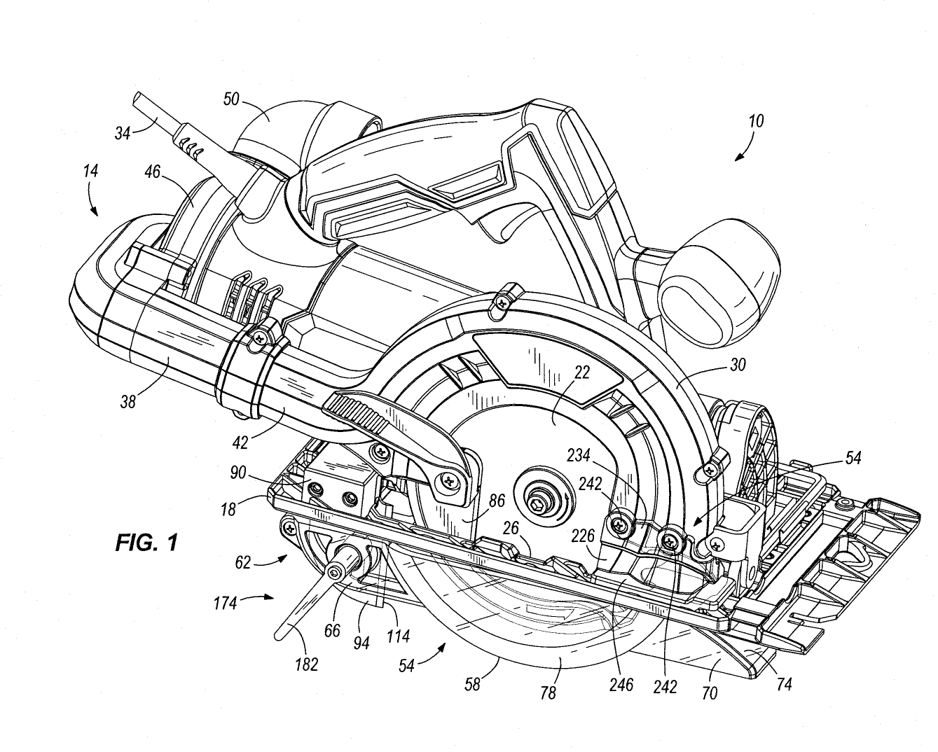

FIG. 1 illustrates a power tool 10 including a vacuum assembly 14 operable to collect or capture debris generated during operation of the power tool 10. In the illustrated construction, the power tool 10 is configured as a circular saw having a base 18, a cutting element (e.g., a circular saw blade 22) extending through an opening 26 in the base 18 for cutting a workpiece supporting the saw 10. Alternatively, the power tool 10 may have any of a number of different configurations for driving a differently configured cutting element (e.g., a reciprocating saw blade, a rotating cutting bit, etc.).

The saw 10 includes an electric motor (not shown) operably coupled to the saw blade 22 via a gear train to rotate the saw blade 22, and a housing or an upper blade guard 30 covering an upper portion of the saw blade 22. Although the illustrated saw 10 includes an AC electric motor powered by household line current through a power cord 34, the motor may be configured as a DC electric motor powered by an on-board battery.

With continued reference to FIG. 1, the vacuum assembly 14 includes an inlet duct 38 in fluid communication with an outlet port 42 of the upper blade guard 30, an impeller housing 46 downstream of the inlet duct 38, and an outlet duct 50 downstream of the impeller housing 46. Although not shown, a container (e.g., a bag, etc.) may be connected to the outlet duct 50 to receive debris collected by the vacuum assembly 14. The vacuum assembly 14 also includes an impeller (not shown) positioned within the impeller housing 46 and driven by the electric motor. The impeller may be driven directly by the electric motor or through a gear train. In operation of the circular saw 10, the motor rotates the impeller whenever the saw blade 22 is driven for cutting a workpiece. The impeller creates a vacuum in the impeller housing 46, the inlet duct 38, and the upper blade guard 30 to draw debris generated by the saw blade 22 (e.g., wood chips, metal shavings, particulate matter, etc.) into the upper blade guard 30, through the inlet duct 38, and into the impeller housing 46 for subsequent discharge through the outlet duct 50 for collection or accumulation in the container. Such a vacuum assembly 14 is also shown and described in published U.S. Patent Application No. 2008/0011138, the entire content of which is incorporated herein by reference.

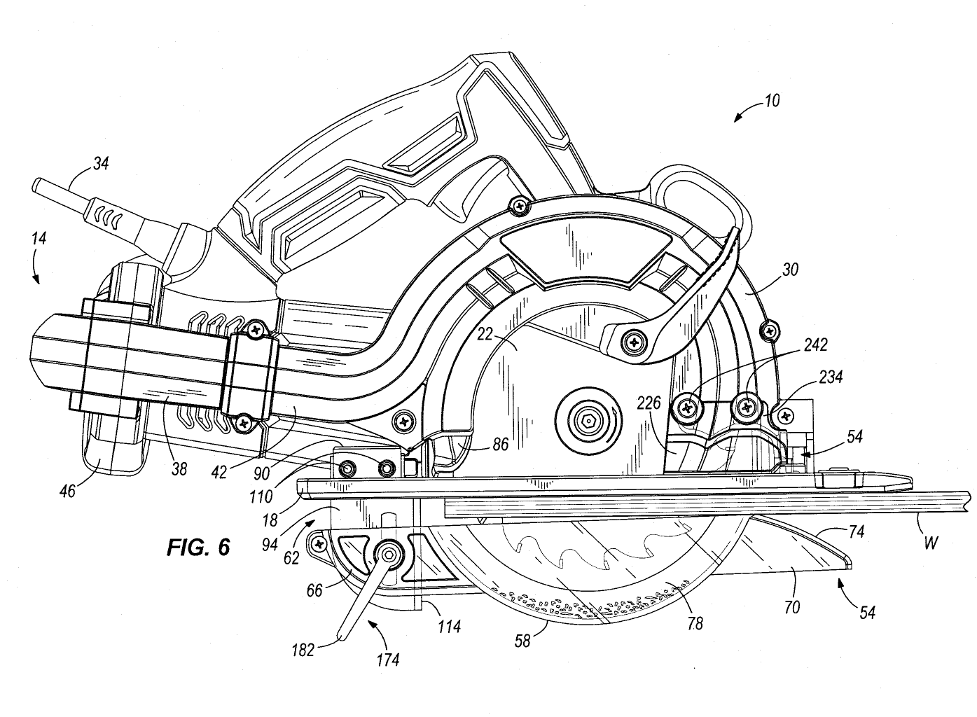

With continued reference to FIG. 1, the circular saw 10 includes a debris collection assembly 54 that is operable to increase the amount of debris collected by the vacuum assembly 14. The debris collection assembly 54 includes a debris collector or a receptacle 58 coupled to the circular saw base 18 via a support 62. As shown in FIG. 6, the circular saw base 18 is supported by a workpiece W as it is being cut, and the receptacle 58 is positioned beneath the base 18 and the workpiece W to collect debris generated by the saw blade 22 beneath the workpiece W as material is removed from the workpiece W.

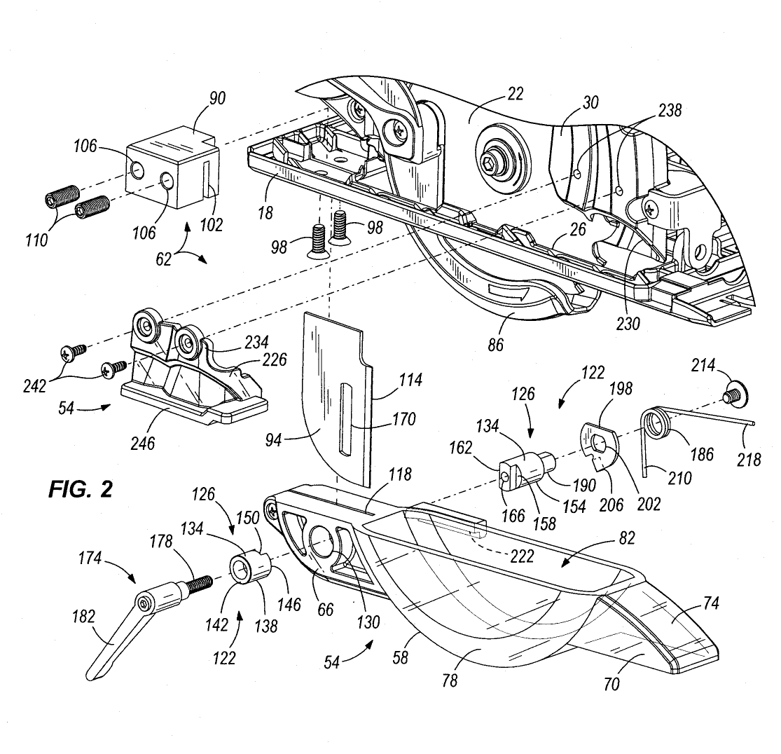

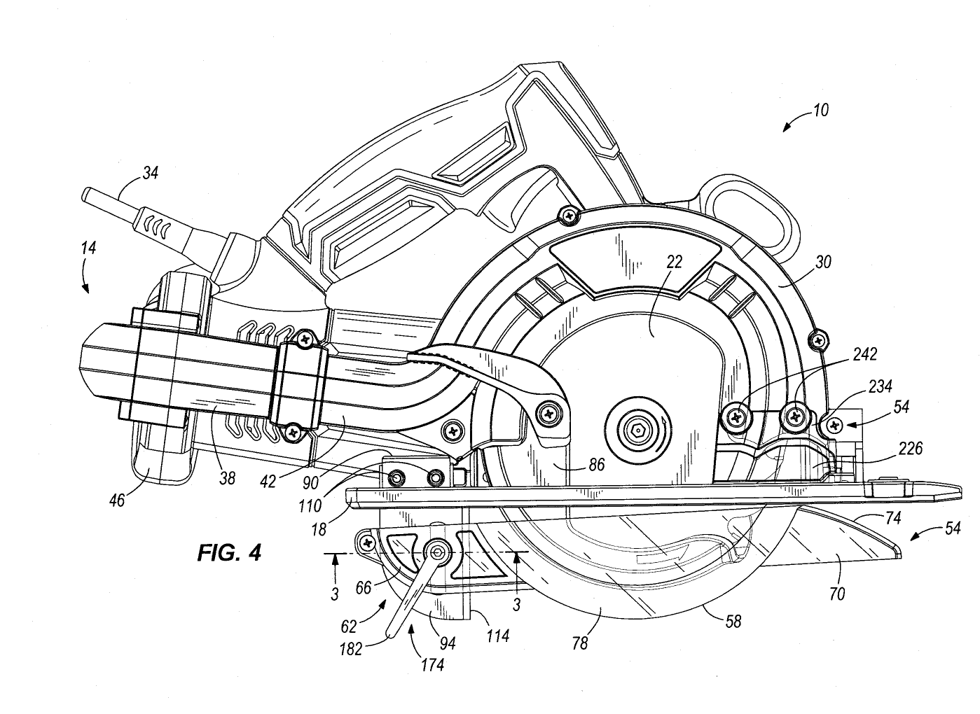

With reference to FIG. 2, the receptacle 58 includes a rear portion 66 coupled to the support 62, a front portion 70 having a ramped surface 74 operable to engage the workpiece W, and an intermediate portion 78 having a trough 82 in which debris may be accumulated. As shown in FIG. 4, the receptacle 58 is cantilevered from the base 18 at the rear portion 66. At least a portion of the saw blade 22 and a lower blade guard 86 is received within the trough 82 when the saw 10 is not being operated to cut a workpiece. When a workpiece is being cut, the lower blade guard 86 is retracted into the upper blade guard 30, such that only a lower portion of the saw blade 22 is received within the trough 82 (FIG. 6). In the illustrated construction of the circular saw 10, the receptacle 58 is made of a translucent material (e.g., a plastic material) such that accumulated debris is visible in the trough 82. Alternatively, the receptacle 58 may be made of an opaque material (e.g., a metal or an opaque plastic material) such that accumulated debris in the trough 82 is not visible unless one is looking directly into the trough 82.

With reference to FIG. 2, the support 62 includes a block 90 coupled to the base 18 and a riving knife 94 coupled to and extending from the block 90. In the illustrated construction of the circular saw 10, the block 90 is fastened to the base 18 using a plurality of fasteners 98 (e.g., screws, etc.). Alternatively, the block 90 may be coupled to the base 18 using any of a number of different ways (e.g., using a snap-fit, an interference or press-fit, using adhesives, by welding, etc.). As a further alternative, the block 90 may be integrally formed with the base 18 as a single piece. The block 90 includes a slot 102 in which the riving knife 94 is received and a plurality of threaded apertures 106 oriented substantially normal to the slot 102. The debris collection assembly 54 also includes a plurality of fasteners (e.g., set screws 110) received within the respective threaded apertures 106 to engage one of the sides of the riving knife 94 to secure the riving knife 94 to the block 90. Alternatively, the riving knife 94 may be coupled to the block 90 in any of a number of different ways (e.g., using a snap-fact, an interference or press-fit, using adhesives, by welding, etc.). As a further alternative, the riving knife 94 may be integrally formed with the block 90 as a single piece. The riving knife 94 is aligned with the saw blade 22, such that an edge 114 of the riving knife 94 is operable to facilitate separation of a workpiece along the cut line.

With continued reference to FIG. 2, the rear portion 66 of the receptacle 58 includes a slot 118 in which the riving knife 94 is received. The width of the slot 118 is sized to permit the rear portion 66 of the receptacle 58 to slide up and down relative to the riving knife 94 (from the orientation of the saw 10 as shown in FIG. 2), while inhibiting movement of the receptacle 58 relative to the riving knife 94 in a direction substantially normal to the orientation of the slot 118 (i.e., in a side-to-side direction).

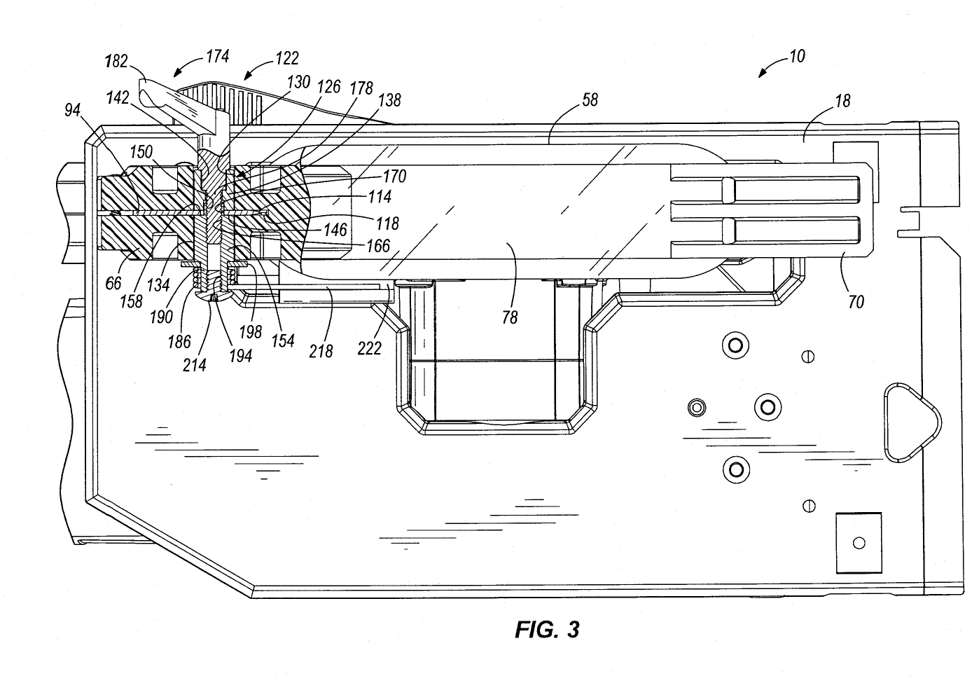

The debris collection assembly 54 further includes a locking assembly 122 operable to secure the position of the rear portion 66 of the receptacle 58 relative to the riving knife 94. The locking assembly 122 includes a two-piece pin 126 received within a cylindrical aperture 130 in the rear portion 66 of the receptacle 58. The pin 126 includes a corresponding cylindrical outer surface 134 to facilitate pivoting of the receptacle 58 about the pin 126 when the locking assembly 122 is in either a locked configuration or an unlocked configuration (described in more detail below). The pin 126 includes a first portion 138 having a stepped, non-threaded aperture 142, an end face 146, and a slot 150 formed in the end face 146 (see also FIG. 3). The pin 126 also includes a second portion 154 having an end face 158, a first projection 162 extending from the end face 158, and a threaded aperture 166 through the first projection 162 (FIG. 2). The first projection 162 is inserted through a slot 170 in the riving knife 94 and is received within the slot 150 to clamp the riving knife 94 between the respective end faces 146, 158 of the first and second portions 138, 154 of the pin 126 (FIG. 3).

With reference to FIG. 2, the locking assembly 122 further includes an actuator 174 having a threaded shank 178 and a lever 182. The shank 178 is inserted through the stepped aperture 142 of the first portion 138 of the pin 126 and received within the threaded aperture 166 in the second portion 154 of the pin 126 (FIG. 3). In this manner, the actuator 174 may be rotated (e.g., in a clockwise direction) to draw the second portion 154 closer to the first portion 138 and clamp the riving knife 94 between the respective end faces 146, 158 of the first and second portions 138, 154 to secure the pin 126, and therefore the receptacle 58, to the riving knife 94. As shown in FIGS. 2 and 3, the actuator 174 is configured as a single piece. Alternatively, the actuator 174 may be configured as multiple pieces (e.g., a lever and a cap screw received in the lever).

With reference to FIG. 2, the locking assembly 122 also includes a resilient member (e.g., a torsion spring 186) operable to bias the front portion 70 of the receptacle 58 toward the base 18. The second portion 154 of the pin 126 includes a second projection 190, extending in an opposite direction as the first projection 162, having a non-circular cross-section and a threaded aperture 194 through the second projection 190 (FIG. 3). In the illustrated construction of the debris collection assembly 54, the threaded apertures 166, 194 in the second portion 154 of the pin 126 are separate from each other. Alternatively, the second portion 154 of the pin 126 may include a single threaded aperture rather than the two distinct threaded apertures 166, 194. With reference to FIG. 2, the locking assembly 122 further includes a washer 198 having an aperture 202 with a non-circular cross-section corresponding to the non-circular cross-section of the second projection 190 such that the washer 198 is rotatably fixed to the second portion 154 of the pin 126 when the second projection 190 is inserted through the aperture 202. Alternatively, the washer 198 may be fixed for co-rotation with the second portion 154 of the pin 126 in any of a number of different ways (e.g., using a snap-fit, an interference or press-fit, using adhesives, by welding, etc.). As a further alternative, the washer 198 may be integrally formed with the second portion 154 of the pin 126 as a single piece.

With continued reference to FIG. 2, the washer 198 includes a tab 206 against which a first end 210 of the spring 186 is engaged, and the locking assembly 122 further includes a threaded fastener (e.g., a screw 214) inserted through the windings of the spring 186 and received in the threaded aperture 194 in the second projection 190. The spring 186 is thereby trapped between the washer 198 and the head of the screw 214 (FIG. 3). A second end 218 of the spring 186 is engaged with a lip 222 on the receptacle 58 (see also FIG. 2). As will be discussed in more detail below, the spring 186 is operable to exert a torque on the receptacle 58 to push the front portion 70 of the receptacle 58 against the base 18 when the circular saw 10 is not being used, and against the underside of a workpiece W when the saw 10 is being used to cut the workpiece.

With reference to FIGS. 1 and 2, the debris collection assembly 54 also includes a shield 226 coupled to the upper blade guard 30. The shield 226 covers an opening 230 in the upper blade guard 30 through which a front portion of the saw blade 22 is otherwise exposed (FIG. 2). Like the receptacle 58, the shield 226 is made of a translucent material (e.g., a plastic material) such that the front portion of the saw blade 22 is visible to an operator of the circular saw 10. Alternatively, the shield 226 may be made of an opaque material (e.g., a metal or an opaque plastic material) such that the front portion of the blade 22 is not visible when viewing the side of the circular saw 10.

With continued reference to FIG. 2, the shield 226 includes a flange 234 coupled to the upper blade guard 30. In the illustrated construction of the circular saw 10, the upper blade guard 30 includes threaded apertures 238 and corresponding threaded fasteners (e.g., screws 242) to attach the flange 234 to the upper blade guard 30. Alternatively, the shield 226 may be coupled to the upper blade guard 30 in any of a number of different ways (e.g., using a snap-fit, using an interference or press-fit, using adhesives, by welding, etc.). As a further alternative, the shield 226 may be movably coupled to the upper blade guard 30 (e.g., using a sliding or pivoting arrangement) to permit the shield 226 to be moved to a position in which the opening 230 in the upper blade guard 30 is at least partially uncovered. Removing the shield 226 (i.e., by removing the screws 242), or moving the shield 226 relative to the upper blade guard 30 (e.g., by sliding or pivoting the shield 226 relative to the upper blade guard 30), may be desirable to facilitate the adjustment of the bevel angle of the saw blade 22 relative to the base 18. Alternatively, rather than removing or moving the shield 226, the base 18 may include a removable or a movable portion that could move out of the way to facilitate adjustment of the bevel angle of the saw blade 22 relative to the base 18.

The shield 226 also includes a base 246 that is engaged with the base 18 of the circular saw 10 to seal the shield 226 to the circular saw base 18 (FIG. 1). In this manner, the shield 226 effectively functions as an extension of the upper blade guard 30 to increase the amount of vacuum available proximate the front portion of the saw blade 22 when a workpiece is being cut.

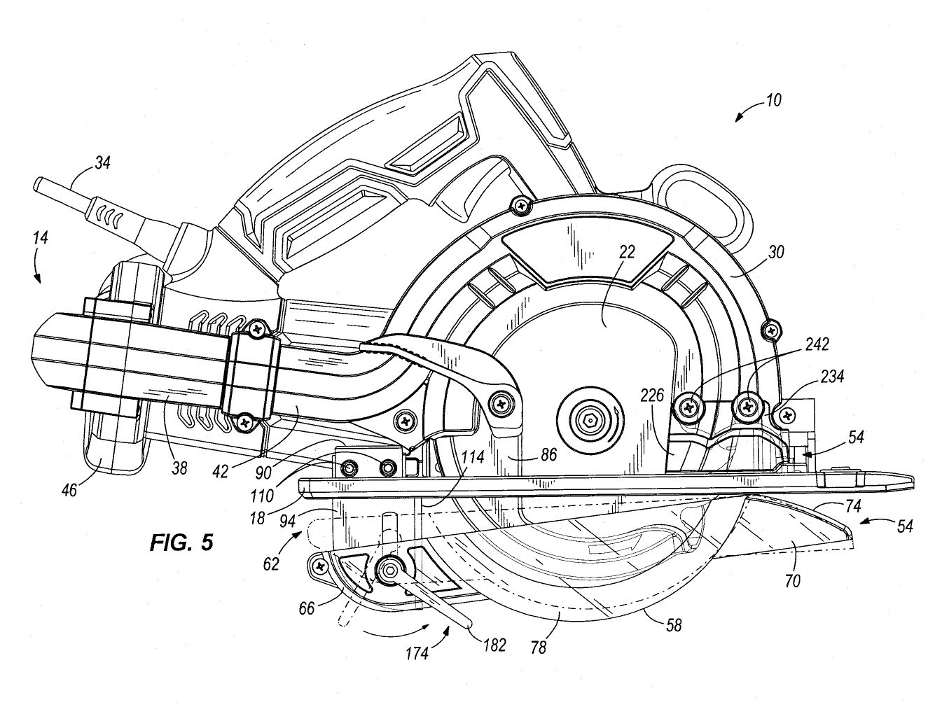

In operation of the circular saw 10, the rear portion 66 of the receptacle 58 may be initially adjusted to a first position relative to the base 18 to accommodate a workpiece having a first thickness (FIG. 4). To adjust the receptacle 58 to accommodate a workpiece having a second thickness greater than the first thickness, the operator of the circular saw 10 would pivot the actuator 174 in a counter-clockwise direction (with respect to the orientation of the circular saw 10 in FIG. 4) to unclamp the pin 126 from the riving knife 94, thereby actuating the locking assembly 122 to an unlocked configuration (FIG. 5). Pivoting the actuator 174 in a counter-clockwise direction causes the respective end faces 146, 158 of the first and second pin portions 138, 154 to disengage or release the riving knife 94. With continued reference to FIG. 5, the operator of the circular saw 10 then adjusts the position of the rear portion 66 of the receptacle 58 by sliding the projection 162 along the slot 170 to a new position relative to the riving knife 94. The actuator 174 is then pivoted in a clockwise direction to re-clamp the riving knife 94 with the respective end faces 146, 158 of the first and second pin portions 138, 154, thereby actuating the locking assembly 122 to a locked configuration. As previously mentioned, the pin 126 permits pivoting of the receptacle 58 relative to the riving knife 94 and the base 18 when the locking assembly 122 is in either the locked or unlocked configurations.

After the operator has adjusted the position of the rear portion 66 of the receptacle 58 to accommodate a workpiece having a particular thickness, the operator may use the circular saw 10 to cut the workpiece. With reference to FIGS. 4 and 5, the spring 186 exerts a torque on the receptacle 58 to bias the front portion 70 of the receptacle 58 toward the base 18. When the saw 10 is initially positioned relative to a workpiece in preparation for cutting the workpiece, movement of the saw 10 in the cutting direction causes an edge of the workpiece to engage the ramped surface 74 of the receptacle 58 which, in turn, pivots the receptacle 58 away from the base 18, about the stationary pin 126, against the bias of the spring 186 (FIG. 6).

As the workpiece is being cut (e.g., the workpiece W in FIG. 6), the front portion 70 of the receptacle 58 remains engaged with the underside of the workpiece W. The receptacle 58 may be adjusted relative to the riving knife 94 to yield a very small gap or space between an upper peripheral edge of the receptacle 58 and the underside of the workpiece W to facilitate sealing the receptacle 58 to the underside of the workpiece W to maximize the amount of debris collected or captured in the trough 82 of the receptacle 58. In addition, the shield 226 substantially prevents any debris from being discharged through the opening 230 in the upper blade guard 30. Rather, such debris is directed to the interior of the upper blade guard 30, where it is suctioned into the inlet duct 38 of the vacuum assembly 14. As a result, less debris is released to the surroundings in which the saw 10 is being used. Testing has shown that the addition of the debris collection assembly 54 to the saw 10 increases the amount of debris collected during a cutting operation by up to 6%.

After the workpiece W is cut, the saw 10 may be operated, without performing a cutting operation, for a brief period of time to activate the vacuum assembly 14 and draw any collected debris in the trough 82 through the opening 26 in the base 18, and into the upper blade guard 30 for subsequent collection by the vacuum assembly 14. In addition to the airflow created by the impeller of the vacuum assembly 14, the rotation of the saw blade 22 also creates an airflow within the trough 82 that directs any collected debris in the trough 82 through the opening 26 in the base 18, and into the upper blade guard 30 for subsequent collection by the vacuum assembly 14.

Various features of the invention are set forth in the following claims.

What is claimed is:

1. A power tool comprising:
a motor;
a cutting element operably coupled to the motor and configured to remove material from a workpiece;
a base configured to support the cutting element relative to the workpiece; and
a receptacle positioned beneath the base and configured to be positioned beneath the workpiece to collect debris generated by the cutting element beneath the workpiece as material is removed from the workpiece.

2. The power tool of claim 1, further comprising
a housing at least partially covering the cutting element, and
a guard at least partially covering the cutting element, wherein the guard is at least partially retractable into the housing to expose the cutting element to the workpiece, and wherein the receptacle is maintained beneath the base and the workpiece when the guard is at least partially retracted into the housing.

3. The power tool of claim 2, wherein the receptacle includes
a front portion engageable with the workpiece, and
a rear portion coupled to the base.

4. The power tool of claim 3, wherein the receptacle is cantilevered from the base.

5. The power tool of claim 3, wherein the receptacle includes an intermediate portion between the front portion and the rear portion, and wherein the guard is at least partially received within the intermediate portion when in an extended position relative to the housing.

6. The power tool of claim 3, further comprising a riving knife coupling the rear portion of the receptacle to the base.

7. The power tool of claim 6, further comprising a locking assembly coupled to at least one of the riving knife and the receptacle, wherein the locking assembly is adjustable between a first configuration, in which a spacing between the rear portion of the receptacle and the base is fixed, and a second configuration, in which the spacing between the rear portion of the receptacle and the base is adjustable.

8. The power tool of claim 7, wherein the locking assembly is also configured to permit pivoting of the receptacle relative to the riving knife when in the first configuration and in the second configuration.

9. The power tool of claim 3, further comprising a resilient member positioned between the base and the receptacle to bias the front portion of the receptacle toward the base.

10. The power tool of claim 2, wherein the cutting element is configured as a circular saw blade, wherein the housing at least partially covers an upper portion of the blade, and wherein the receptacle at least partially covers a lower portion of the blade.

11. The power tool of claim 1, further comprising
a housing at least partially covering the cutting element,
an opening in the housing through which the cutting element is exposed, and
a shield coupled to the housing and at least partially covering the opening in the housing.

12. The power tool of claim 11, wherein the shield is positioned proximate a front portion of the housing and above the base.

13. The power tool of claim 11, wherein the cutting element is configured as a circular saw blade, and wherein the housing at least partially covers an upper portion of the blade.

14. The power tool of claim 1, wherein the power tool is configured as a circular saw, and wherein the cutting element is configured as a circular saw blade.

15. A debris collection assembly for use with a circular saw, the circular saw including a circular saw blade, a base configured to support the saw blade relative to a workpiece, and a lower guard positionable to at least partially cover a lower portion of the saw blade, the debris collection assembly comprising:
a support configured to be coupled to the base;
a receptacle coupled to the support and configured to be positioned beneath the base and the workpiece to collect debris generated by the saw blade beneath the workpiece as material is removed from the workpiece; and
a locking assembly coupled to at least one of the support and the receptacle, wherein the locking assembly is adjustable between a first configuration, in which the position of the receptacle relative to the support is fixed, and a second configuration, in which the position of the receptacle relative to the support is adjustable.

16. The debris collection assembly of claim 15, wherein the receptacle includes
a front portion engageable with the workpiece, and
a rear portion coupled to the support.

17. The debris collection assembly of claim 16, wherein the receptacle includes an intermediate portion between the front portion and the rear portion, and wherein the lower guard is at least partially received within the intermediate portion when positioned to cover the lower portion of the saw blade.

18. The debris collection assembly of claim 16, further comprising a resilient member positioned between the support and the receptacle to bias the front portion of the receptacle toward the base.

19. The debris collection assembly of claim 15, wherein the support is configured as a riving knife.

20. The debris collection assembly of claim 15 wherein the locking assembly is also configured to permit pivoting of the receptacle relative to the support when in the first configuration and in the second configuration.
